(19) United States
(12) Patent Application Publication
(10) Pub. No.: US 2025/0226617 A1
(43) Pub. Date: Jul. 10, 2025

(54) Electrical Connector

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 18/661,587

(22) Filed: May 11, 2024

(30) Foreign Application Priority Data
Jan. 5, 2024 (CN) 202410018897.4

(51) Int. Cl. H01R 13/652; H01R 13/02; H01R 13/502; H01R 13/6581

(52) U.S. Cl. CPC H01R 13/652; H01R 13/02; H01R 13/502; H01R 13/6581

(57) ABSTRACT

An electrical connector is described that provides a shielding wall for at least three sides of non-grounded conductive terminals, enabling the transmission of shielded signals. This design effectively reduces interference for the electrical connector when transmitting high-speed signals, thereby optimizing the transmission quality of high-speed signals for the electrical connector. This meets the specific requirements and advancements in electronic devices.

### CROSS-REFERENCE TO RELATED APPLICATIONS

This application claims the priority of China Patent Application No. 202410018897.4 filed on Jan. 5, 2024, in the State Intellectual Property Office of China, the disclosure of which is incorporated herein by reference.

### BACKGROUND OF THE INVENTION

### Field of the Invention

This application relates to the field of electronic device technology, more specifically, to an electrical connector aimed at reducing interference levels when transmitting high-speed signals.

### Descriptions of the Related Art

In recent years, electrical connectors have been widely used in various electronic devices to transmit signals through a plurality of conductive terminals on the connector. However, with the special requirements and development of electronic devices, there may also be a need for the plurality of conductive terminals of the electrical connector to transmit high-speed signals. Currently, electrical connectors are prone to interference when transmitting high-speed signals (such interference may include external electromagnetic interference or crosstalk interference between the plurality of conductive terminals of the connector), resulting in attenuation of the transmitted high-speed signals of the electrical connectors.

From the above we can know addressing the issue of electrical connectors being prone to interference during the transmission of high-speed signals is a pressing concern for professionals in the field.

### SUMMARY OF THE INVENTION

In view of the drawbacks of the prior art mentioned above, the present application provides an electrical connector, where one side is referred to as an electrical connector major side, comprises: a conductive plastic base, including a major conductive plastic base body, a major first conductive plastic wall structure, and a major second conductive plastic wall structure, and the major conductive plastic base body is electrically connected to the major first conductive plastic wall structure and the major second conductive plastic wall structure; a major conductive terminal assembly, located on the electrical connector major side, consisting of a major first grounding conductive terminal, a major second grounding conductive terminal, and a major non-grounding conductive terminal; and a major insulation terminal base, integrated with the conductive plastic base to form a major conductive terminal mounting module, and the major conductive terminal mounting module provides for the installation of the major first grounding conductive terminal, the major second grounding conductive terminal, and the major non-grounding conductive terminal; in the major conductive terminal mounting module, the major non-grounding conductive terminal is positioned between the major first grounding conductive terminal and the major second grounding conductive terminal; and the major first conductive plastic wall structure and the major second conductive plastic wall structure are respectively abutted against the major first grounding conductive terminal and the major second grounding conductive terminal, enabling the conductive plastic base to electrically connect the major first grounding conductive terminal and the major second grounding conductive terminal, allowing the major conductive plastic base body, the major first conductive plastic wall structure, the major second conductive plastic wall structure, the major first grounding conductive terminal, and the major second grounding conductive terminal to form a major non-grounding terminal shielding wall, wherein the major non-grounding terminal shielding wall has a U-shaped cross-section, allowing the major non-grounding terminal shielding wall to provide shielding on at least three sides of the major non-grounding conductive terminal.

Preferably, the electrical connector said above, wherein the front end of the electrical connector is an electrical connector front end, and the electrical connector further comprises a major front conductive connecting body, wherein the major front conductive connecting body extends at the electrical connector front end and spans over the major non-grounding conductive terminal, electrically connecting the major first grounding conductive terminal and the major second grounding conductive terminal, enabling the major front conductive connecting body to electrically connect to the major non-grounding terminal shielding wall, thereby providing electrical shielding to the major non-grounding conductive terminal at the electrical connector front end, wherein the major first grounding conductive terminal has a major first grounding terminal front joining structure, the major second grounding conductive terminal has a major second grounding terminal front joining structure, and the major non-grounding conductive terminal has a major non-grounding terminal front joining structure. The major first grounding terminal front joining structure, the major second grounding terminal front joining structure, and the major non-grounding terminal front joining structure are located at the electrical connector front end.

Preferably, the electrical connector said above, wherein the major front conductive connecting body comprises a major front wall shielding structure, and the major front wall shielding structure is provided at the electrical connector front end to serve as a shielding wall for the major non-grounding conductive terminal.

Preferably, the electrical connector said above, wherein the major front conductive connecting body comprises a major front connector hollow structure, and the major front connector hollow structure is hollowed out at the electrical connector front end to provide impedance matching for the major non-grounding conductive terminal.

Preferably, the electrical connector said above, wherein the major conductive plastic base body extends around one side of the major non-grounding conductive terminal.

Preferably, the electrical connector said above, wherein the rear end of the electrical connector is an electrical connector rear end, and the electrical connector also comprises a major rear conductive connecting body, and the major rear conductive connecting body extends at the electrical connector rear end and spans over the major non-grounding conductive terminal, electrically connecting the major first grounding conductive terminal and the major second grounding conductive terminal, enabling the major rear conductive connecting body to electrically connect to the major non-grounding terminal shielding wall, thereby providing electrical shielding to the major non-grounding conductive terminal at the electrical connector rear end, wherein the major first grounding conductive terminal has a major first grounding terminal rear joining structure, the major second grounding conductive terminal a major second grounding terminal rear joining structure, and the major non-grounding conductive terminal respectively has a major non-grounding terminal rear joining structure. The major first grounding terminal rear joining structure, the major second grounding terminal rear joining structure, and the major non-grounding terminal rear joining structure are located at the electrical connector rear end.

Preferably, the electrical connector said above, wherein the major non-grounding conductive terminal also includes a major non-grounding terminal rear bend structure, and the major non-grounding terminal rear bend structure provides bending to divert the major non-grounding conductive terminal away from the major rear conductive connecting body, and the major first conductive plastic wall structure and the major second conductive plastic wall structure extend from the lateral side of the major non-grounding terminal rear bend structure to provide a shielding wall for the major non-grounding terminal rear bend structure.

Preferably, the electrical connector said above, wherein the major first grounding conductive terminal and the major second grounding conductive terminal are respectively inserted into the major first conductive plastic wall structure and the major second conductive plastic wall structure, allowing the major first grounding conductive terminal and the major second grounding conductive terminal to electrically connect to the conductive plastic base.

Preferably, the electrical connector said above, wherein the major conductive terminal mounting module is located at the major insulation terminal base, and the major first conductive plastic wall structure and the major second conductive plastic wall structure respectively enter the major insulation terminal base, enabling to individually abut against the major first grounding conductive terminal and the major second grounding conductive terminal.

Preferably, the electrical connector said above, wherein the major first conductive plastic wall structure and the major second conductive plastic wall structure individually abut against the major first grounding conductive terminal and the major second grounding conductive terminal in surface contact, providing structural support for the major first grounding conductive terminal and the major second grounding conductive terminal respectively.

Preferably, the electrical connector said above, wherein the other side of the electrical connector is an electrical connector minor side, wherein the conductive plastic base also comprises a minor conductive plastic base body, a minor first conductive plastic wall structure, and a minor second conductive plastic wall structure, and the minor conductive plastic base body electrically connects the minor first conductive plastic wall structure and the minor second conductive plastic wall structure, and the electrical connector further includes a minor conductive terminal assembly, located on the electrical connector minor side, comprising a minor first grounding conductive terminal, a minor second grounding conductive terminal, and a minor non-grounding conductive terminal; and a minor insulation terminal base, attached to the conductive plastic base to form a minor conductive terminal mounting module, and the minor conductive terminal mounting module provides placement for the minor first grounding conductive terminal, the minor second grounding conductive terminal, and the minor non-grounding conductive terminal; within the minor conductive terminal mounting module, the minor non-grounding conductive terminal is positioned between the minor first grounding conductive terminal and the minor second grounding conductive terminal; and the minor first conductive plastic wall structure and the minor second conductive plastic wall structure are respectively abutted against the minor first grounding conductive terminal and the minor second grounding conductive terminal, enabling the conductive plastic base to electrically connect to the minor first grounding conductive terminal and the minor second grounding conductive terminal, allowing the minor conductive plastic base body, the minor first conductive plastic wall structure, the minor second conductive plastic wall structure, the minor first grounding conductive terminal and the minor second grounding conductive terminal to form a minor non-grounding terminal shielding wall, and the minor non-grounding terminal shielding wall has a U-shaped cross-section, allowing the minor non-grounding terminal shielding wall to provide shielding walls on at least three sides of the minor non-grounding conductive terminal.

Preferably, the electrical connector said above, wherein the front end of the electrical connector is an electrical connector front end, and the electrical connector includes a minor front conductive connecting body, and the minor front conductive connecting body extends at the electrical connector front end and spans over the minor non-grounding conductive terminal, electrically connecting the minor first grounding conductive terminal and the minor second grounding conductive terminal, enabling the minor front conductive connecting body to electrically connect to the minor non-grounding terminal shielding wall and to provide the electrical shielding to the minor non-grounding conductive terminal at the electrical connector front end, wherein the minor first grounding conductive terminal has a minor first grounding terminal front joining structure, the minor second grounding conductive terminal has a minor second grounding terminal front joining structure and the minor non-grounding conductive terminal has a minor non-grounding terminal front joining structure. The minor first grounding terminal front joining structure, the minor second grounding terminal front joining structure, and the minor non-grounding terminal front joining structure are located at the electrical connector front end.

Preferably, the electrical connector said above, wherein the minor front conductive connecting body comprises a minor front wall shielding structure, and the minor front wall shielding structure is provided at the electrical connector front end to serve as a shielding wall for the minor non-grounding conductive terminal.

Preferably, the electrical connector said above, wherein the minor front conductive connecting body comprises a minor front connector hollow structure, and the minor front connector hollow structure is hollowed out at the electrical connector front end to provide impedance matching for the minor non-grounding conductive terminal.

Preferably, the electrical connector said above, wherein the minor conductive plastic base body extends around one side of the minor non-grounding conductive terminal.

Preferably, the electrical connector said above, wherein the rear end of the electrical connector is an electrical connector rear end, and the electrical connector also comprises a minor rear conductive connecting body, and the minor rear conductive connecting body extends at the electrical connector rear end and spans over the minor non-grounding conductive terminal, electrically connecting the minor first grounding conductive terminal and the minor second grounding conductive terminal, enabling the minor rear conductive connecting body to electrically connect to the minor non-grounding terminal shielding wall, thereby providing electrical shielding to the minor non-grounding conductive terminal at the electrical connector rear end, wherein the minor first grounding conductive terminal has a minor first grounding terminal rear joining structure, the minor second grounding conductive terminal has a minor second grounding terminal rear joining structure, and the minor non-grounding conductive terminal has a minor non-grounding terminal rear joining structure. The minor first grounding terminal rear joining structure, the minor second grounding terminal rear joining structure, and the minor non-grounding terminal rear joining structure are located at the electrical connector rear end.

Preferably, the electrical connector said above, wherein the minor non-grounding conductive terminal also includes a minor non-grounding terminal rear bend structure, and the minor non-grounding terminal rear bend structure provides bending to divert the minor non-grounding conductive terminal away from the minor rear conductive connecting body, and the minor first conductive plastic wall structure and the minor second conductive plastic wall structure extend from the lateral side of the minor non-grounding terminal rear bend structure to provide a shielding wall for the minor non-grounding terminal rear bend structure.

Preferably, the electrical connector said above, wherein the minor first grounding conductive terminal and the minor second grounding conductive terminal are respectively inserted into the minor first conductive plastic wall structure and the minor second conductive plastic wall structure, allowing the minor first grounding conductive terminal and the minor second grounding conductive terminal to electrically connect to the conductive plastic base.

Preferably, the electrical connector said above, wherein the minor conductive terminal mounting module is located at the minor insulation terminal base, and the minor first conductive plastic wall structure and the minor second conductive plastic wall structure respectively enter the minor insulation terminal base, enabling to individually abut against the minor first grounding conductive terminal and the minor second grounding conductive terminal.

Preferably, the electrical connector said above, wherein the minor first conductive plastic wall structure and the minor second conductive plastic wall structure individually abut against the minor first grounding conductive terminal and the minor second grounding conductive terminal in surface contact, providing structural support for the minor first grounding conductive terminal and the minor second grounding conductive terminal respectively.

Preferably, the electrical connector said above, wherein the major insulation terminal base and the minor insulation terminal base can be formed separately or integrally.

Preferably, the electrical connector said above, wherein the major conductive plastic base body and the minor conductive plastic base body can be formed separately or integrally.

In comparison to prior art, electrical connector provided in this application can provide shielding walls to transmit shielded signals for at least three sides of the non-grounding conductive terminal, thereby effectively reducing interference when transmitting high-speed signals, and optimizing the transmission quality of the electrical connector for high-speed signals to meet the specific requirements and advancements of electronic devices.

### BRIEF DESCRIPTION OF THE DRAWINGS

The above and other aspects, has and other advantages of the present invention will be more clearly understood from the following detailed description taken in conjunction with the accompanying drawings, in which:

FIG. 1 is a three-dimensional schematic diagram of the electrical connector of the present application from a first perspective in an embodiment.

FIG. 2 is a three-dimensional schematic diagram of the electrical connector of the present application from a second perspective in an embodiment.

FIG. 3 is a top view schematic diagram of the electrical connector of the present application in an embodiment.

FIG. 4 is a sectional schematic diagram of some components of the electrical connector shown in FIG. 3 cut along the line AA.

FIG. 5 is a sectional schematic diagram of some components of the electrical connector shown in FIG. 3 cut along the line BB.

FIG. 6 is a sectional schematic diagram of some components of the electrical connector shown in FIG. 3 cut along the line CC.

FIG. 7 is a three-dimensional schematic diagram of some components of the electrical connector according to the present application from a first perspective in an embodiment.

FIG. 8 is a three-dimensional schematic diagram of some components of the electrical connector according to the present application from a second perspective in an embodiment.

FIG. 9 is a three-dimensional schematic diagram of some components of the electrical connector according to the present application from a first perspective in an embodiment.

FIG. 10 is a three-dimensional schematic diagram of some components of the electrical connector according to the present application from a second perspective in an embodiment.

FIG. 11 is a three-dimensional schematic diagram of some components of the electrical connector according to the present application from a first perspective in an embodiment.

FIG. 12 is a three-dimensional schematic diagram of some components of the electrical connector according to the present application from a second perspective in an embodiment.

FIG. 13 is a three-dimensional schematic diagram of some components of the electrical connector according to the present application from a first perspective in an embodiment.

FIG. 14 is a three-dimensional schematic diagram of some components of the electrical connector according to the present application from a second perspective in an embodiment.

FIG. 15 is a three-dimensional schematic diagram of some components of the electrical connector according to the present application from a first perspective in an embodiment.

FIG. 16 is a three-dimensional schematic diagram of some components of the electrical connector according to the present application from a second perspective in an embodiment.

FIG. 17 is a three-dimensional schematic diagram of some components of the electrical connector according to the present application in an embodiment.

FIG. 18 is a three-dimensional schematic diagram of some components of the electrical connector according to the present application in an embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

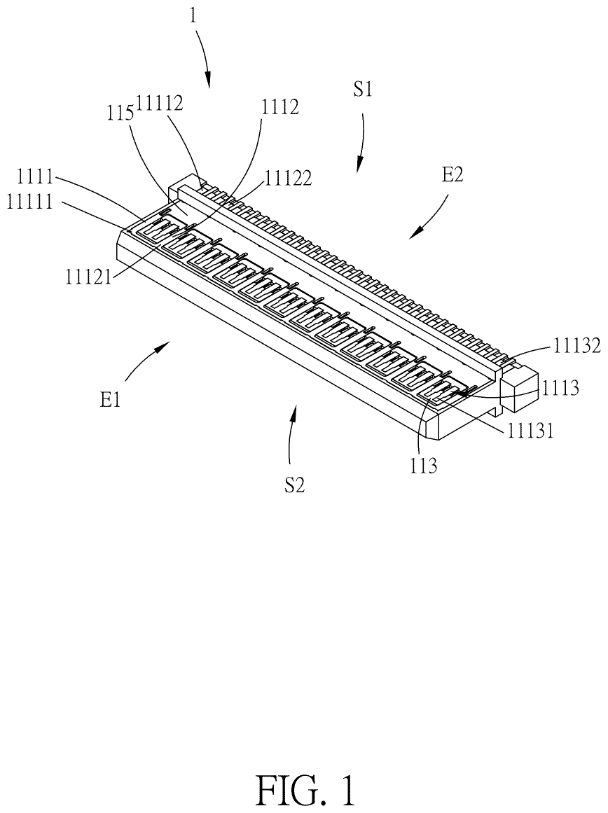

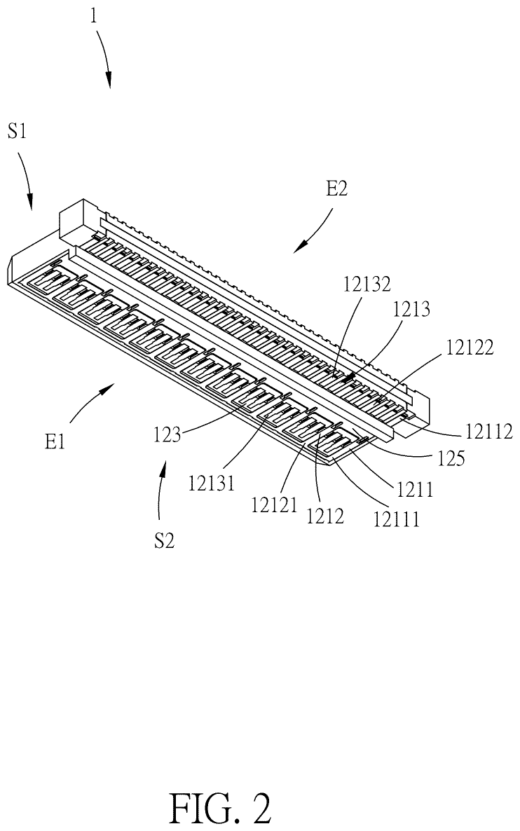

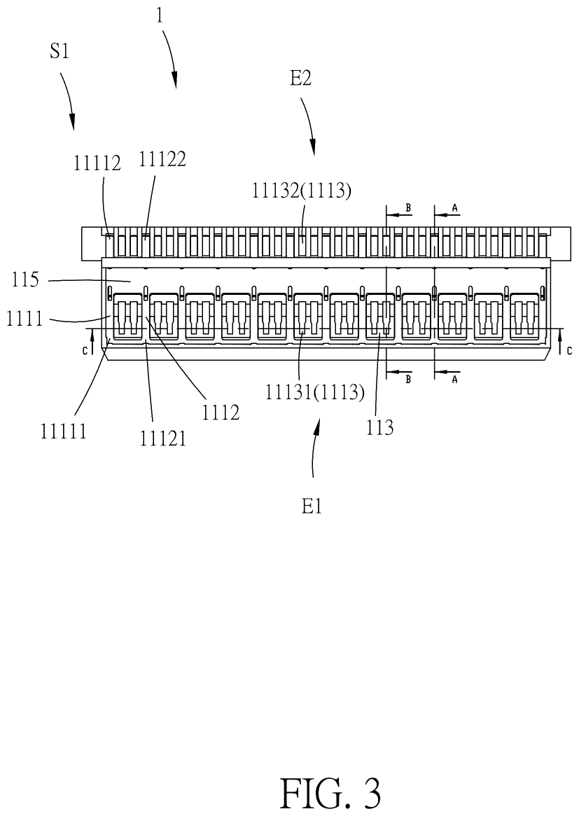

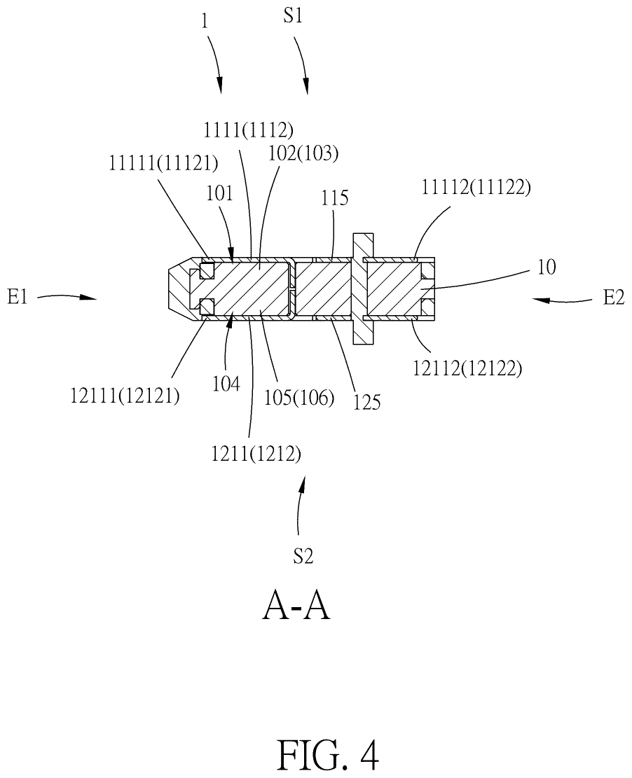

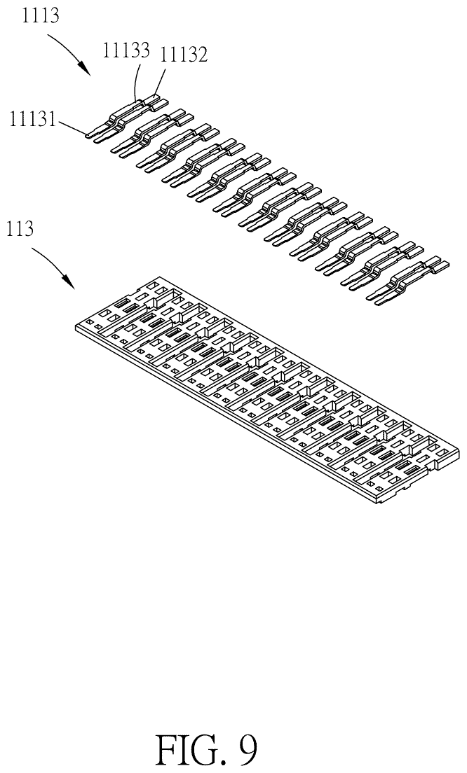

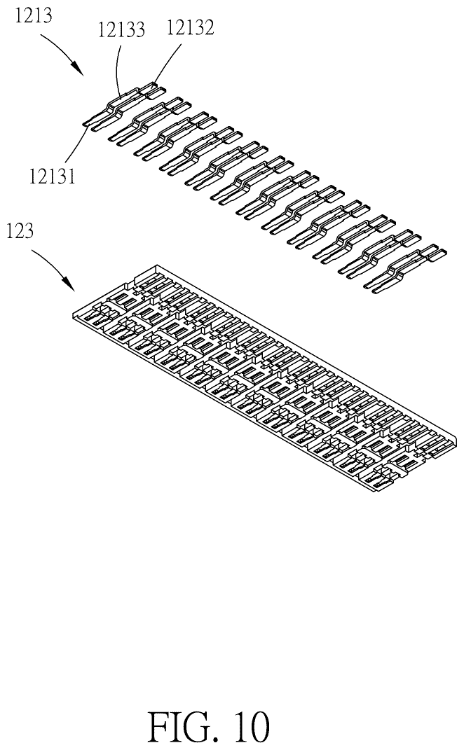

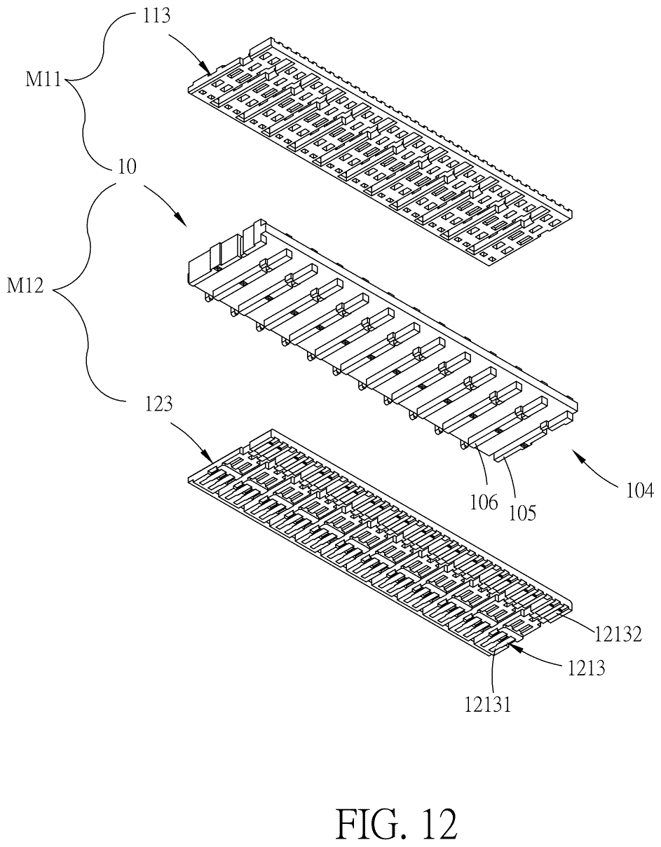

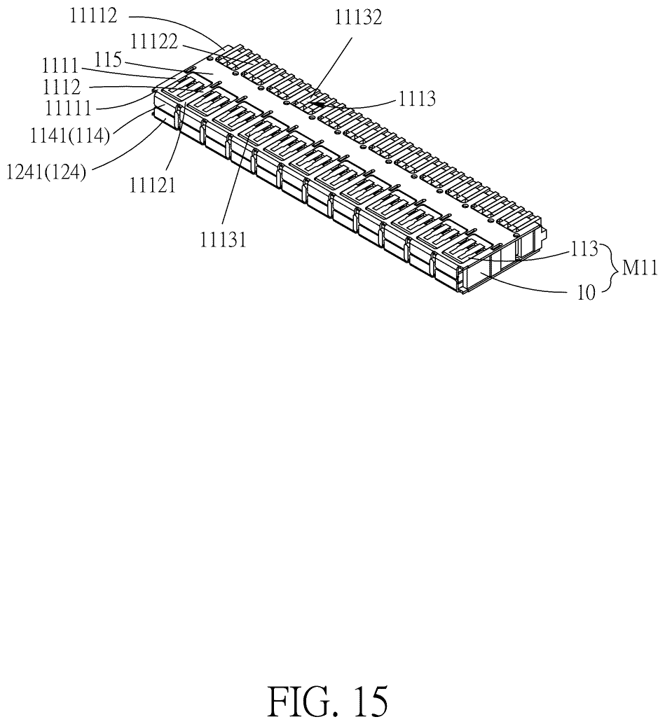

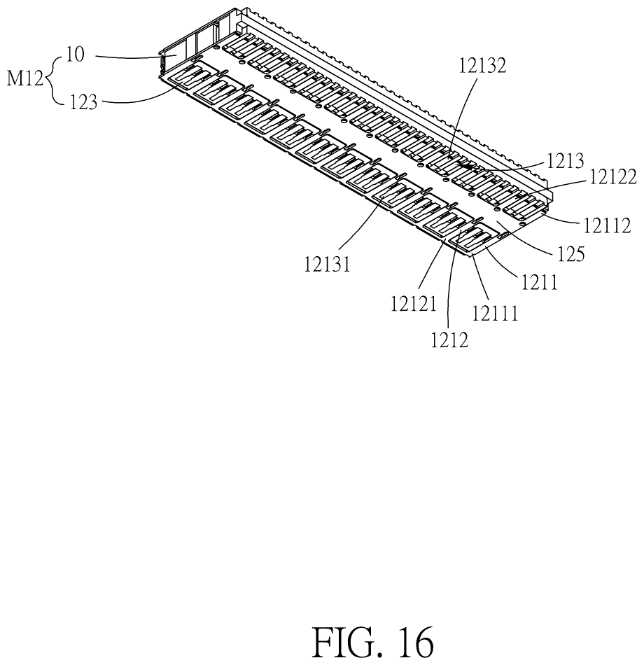

For a detailed description of the embodiments disclosed in the present application, please refer to FIGS. 1 to 18.

In the above embodiment, provided is an electrical connector 1 that can be installed in electronic devices. In the electronic device, the electrical connector 1 is capable of respectively joining a front-end conductive component and a rear-end conductive component to provide signal transmission. Additionally, the two sides of the electrical connector 1 is respectively defined as an electrical connector major side S1 and an electrical connector minor side S2, while the front and rear ends of the electrical connector 1 are respectively defined as an electrical connector front end E1 and an electrical connector rear end E2.

It should be noted that in the above embodiment, the electrical connector 1 can join to the front-end conductive component on the electrical connector major side S1, the electrical connector minor side S2 and the electrical connector front end E1. Additionally, the electrical connector 1 can join to the rear-end conductive component on the electrical connector major side S1, the electrical connector minor side S2 and the electrical connector rear end E2.

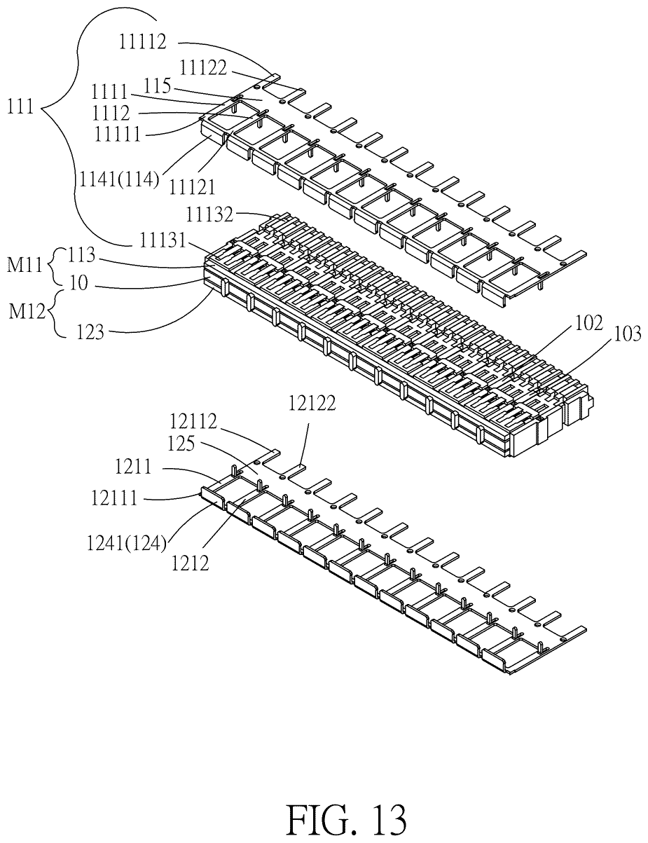

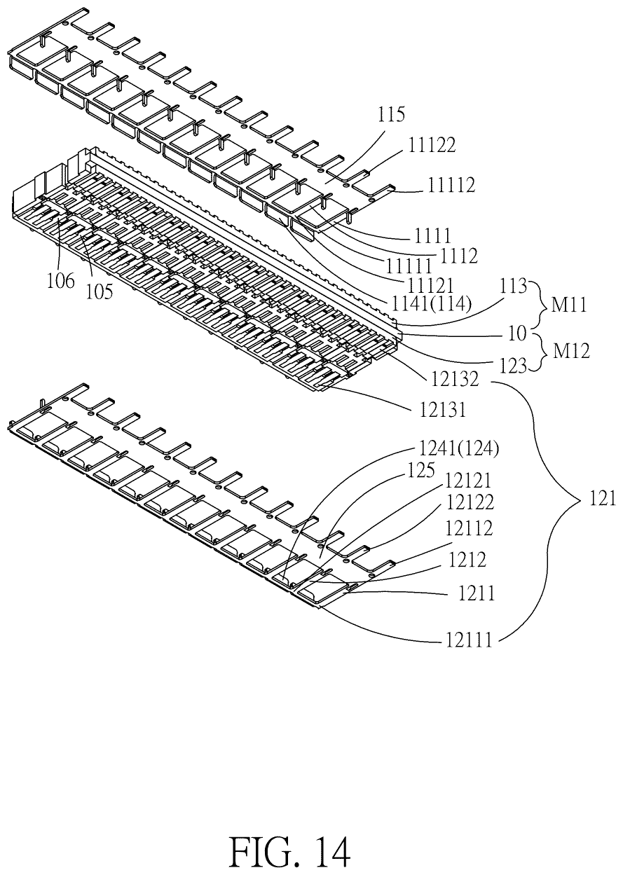

In the embodiments shown in FIGS. 13 to 14, the electrical connector 1 comprises: a conductive plastic base 10, a major conductive terminal assembly 111, a minor conductive terminal assembly 121, a major insulation terminal base 113, a minor insulation terminal base 123, a major front conductive connecting body 114, a minor front conductive connecting body 124, a major rear conductive connecting body 115, and a minor rear conductive connecting body 125.

It should be noted that the conductive plastic base 10 can be made of conductive plastic material, capable of providing to transmit shielded signals such as ground signals. The major insulation terminal base 113 and the minor insulation terminal base 123 can be made of insulating material, providing positioning for the major conductive terminal assembly 111 and the minor conductive terminal assembly 121, respectively.

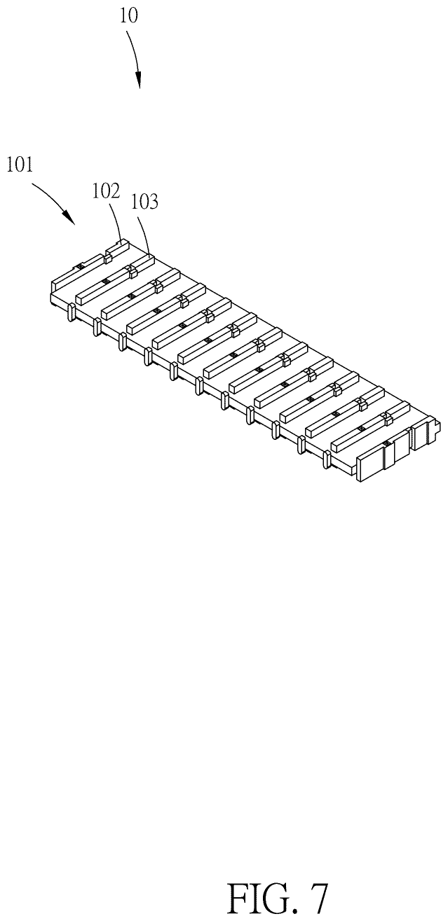

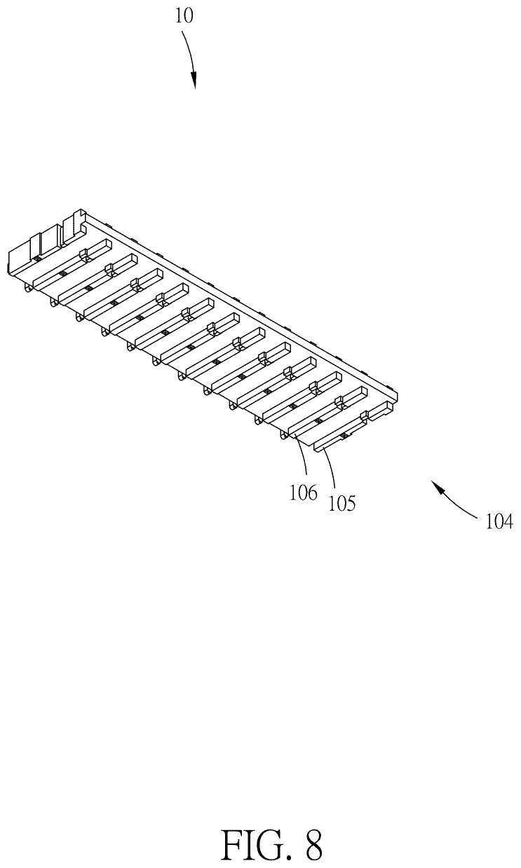

As shown in FIGS. 7 to 8, the conductive plastic base 10 comprises a major conductive plastic base body 101, a major first conductive plastic wall structure 102, a major second conductive plastic wall structure 103, a minor conductive plastic base body 104, a minor first conductive plastic wall structure 105, and a minor second conductive plastic wall structure 106.

It should be noted that, in this application, the major insulation terminal base 113 and the minor insulation terminal base 123 can be optionally formed separately or integrally. Similarly, the major conductive plastic base body 101 and the minor conductive plastic base body 104 can also be optionally formed separately or integrally.

As shown in FIGS. 1 to 3, the major conductive terminal assembly 111 is located on the electrical connector major side S1 and consists of a major first grounding conductive terminal 1111, a major second grounding conductive terminal 1112, and a major non-grounding conductive terminal 1113. The minor conductive terminal assembly 121 is located on the electrical connector minor side S2 and consists of a minor first grounding conductive terminal 1211, a minor second grounding conductive terminal 1212, and a minor non-grounding conductive terminal 1213.

It should be noted that the major first grounding conductive terminal 1111, the major second grounding conductive terminal 1112, the minor first grounding conductive terminal 1211, and the minor second grounding conductive terminal 1212 can provide transmission of grounding signals, and the number of the major first grounding conductive terminal 1111, the major second grounding conductive terminal 1112, the minor first grounding conductive terminal 1211, and the minor second grounding conductive terminal 1212 is not limited to one. The major non-grounding conductive terminal 1113 and the minor non-grounding conductive terminal 1213 can provide transmission of non-grounding signals, such as differential signals, and the number of the major non-grounding conductive terminal 1113 and the minor non-grounding conductive terminal 1213 is not limited to one.

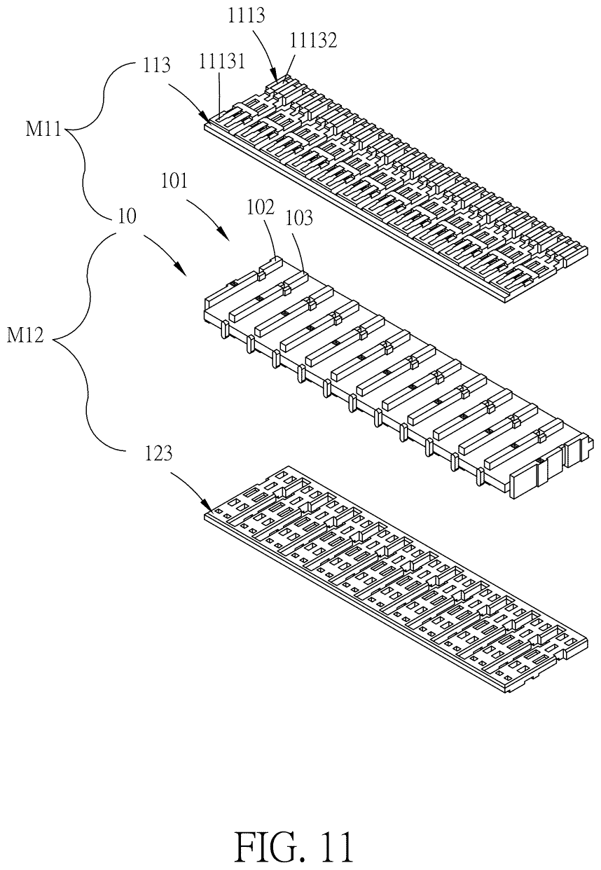

In the embodiments shown in FIGS. 11 to 15 and FIGS. 17 to 18, the major insulation terminal base 113 is combined (or connected) with the conductive plastic base 10 to form a major conductive terminal mounting module M11. The major conductive terminal mounting module M11 provides the installation of the major first grounding conductive terminal 1111, the major second grounding conductive terminal 1112, and the major non-grounding conductive terminal 1113.

It should be noted that, in the major conductive terminal mounting module M11, the major non-grounding conductive terminal 1113 is positioned between the major first grounding conductive terminal 1111 and the major second grounding conductive terminal 1112. The major first conductive plastic wall structure 102 and the major second conductive plastic wall structure 103 are respectively abutted against the major first grounding conductive terminal 1111 and the major second grounding conductive terminal 1112, enabling the conductive plastic base 10 to electrically connect the major first grounding conductive terminal 1111 and the major second grounding conductive terminal 1112 to allow the major conductive plastic base body 101, the major first conductive plastic wall structure 102, the major second conductive plastic wall structure 103, the major first grounding conductive terminal 1111, and the major second grounding conductive terminal 1112 to form a major non-grounding terminal shielding wall W1. The major non-grounding terminal shielding wall W1 is capable of transmitting shielding signals, such as grounding signals, and has a U-shaped cross-section, allowing the major non-grounding terminal shielding wall W1 to provide shielding wall on at least three sides of the major non-grounding conductive terminal 1113 to create an electrically shielded environment for signal transmission of the major non-grounding conductive terminal 1113, thereby reducing interference when transmitting high-speed signals. This optimization enhances the transmission quality of the electrical connector 1 for high-speed signals, meeting the specific requirements and advancements in electronic devices.

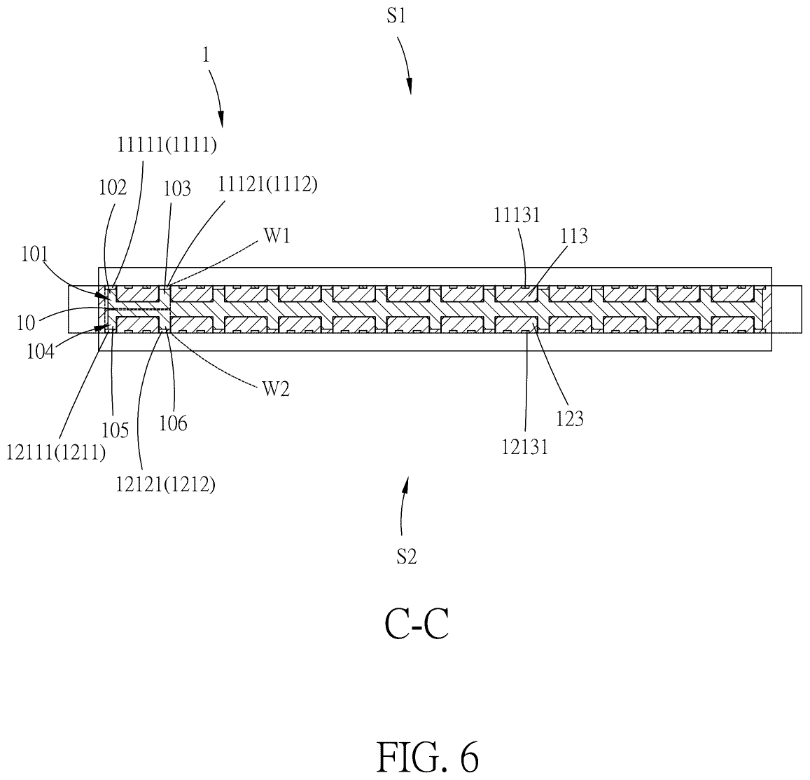

As shown in FIGS. 6, 11, and 17, the major conductive plastic base body 101 electrically connects to the major first conductive plastic wall structure 102 and the major second conductive plastic wall structure 103, enabling to provide transmission of shielding signals, such as grounding signals. Additionally, the major conductive plastic base body 101 extends around one side of the major non-grounding conductive terminal 1113, thereby providing an electrically shielded environment for signal transmission of the major non-grounding conductive terminal 1113.

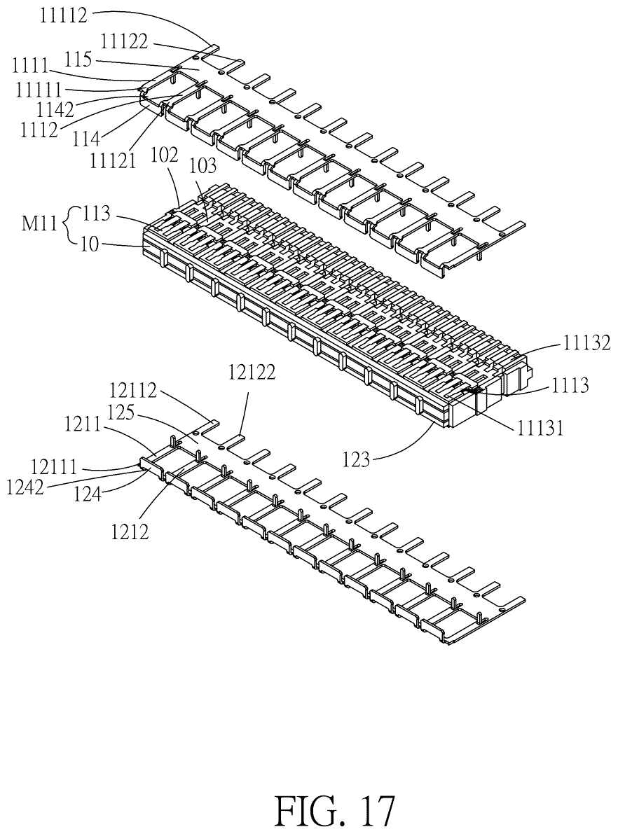

Additionally, as shown in FIGS. 6 and 13, the major first grounding conductive terminal 1111 and the major second grounding conductive terminal 1112 are respectively inserted into the major first conductive plastic wall structure 102 and the major second conductive plastic wall structure 103, enabling the major first grounding conductive terminal 1111 and the major second grounding conductive terminal 1112 to electrically connect to the conductive plastic base 10. As shown in FIGS. 11 and 17, the major conductive terminal mounting module M11 is located at the major insulation terminal base 113. The major first conductive plastic wall structure 102 and the major second conductive plastic wall structure 103 respectively enter the major insulation terminal base 113, thereby enabling to respectively abut to the major first grounding conductive terminal 1111 and the major second grounding conductive terminal 1112 in the way such as surface contact, respectively providing structural support to the major first grounding conductive terminal 1111 and the major second grounding conductive terminal 1112, reducing the degree of deformation experienced by the major first grounding conductive terminal 1111 and the major second grounding conductive terminal 1112.

The major first grounding conductive terminal 1111 has a major first grounding terminal front joining structure 11111. The major second grounding conductive terminal 1112 has a major second grounding terminal front joining structure 11121. The major non-grounding conductive terminal 1113 has a major non-grounding terminal front joining structure 11131. The major first grounding terminal front joining structure 11111, the major second grounding terminal front joining structure 11121, and the major non-grounding terminal front joining structure 11131 can be respectively joined to the front end conductive component at the electrical connector front end E1 to provide the transmission of electrical signals.

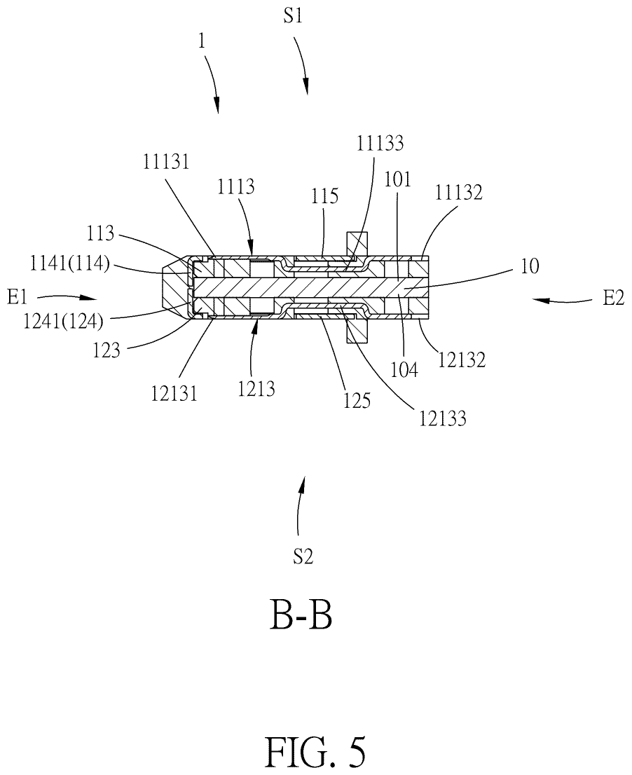

Additionally, as shown in FIGS. 5 and 6, the major front conductive connecting body 114 extends at the electrical connector front end E1 and spans over the major non-grounding conductive terminal 1113, and electrically connects to the major first grounding conductive terminal 1111 and the major second grounding conductive terminal 1112, allowing the major front conductive connecting body 114 to electrically connect to the major non-grounding terminal shielding wall W1, providing shielding wall to the major non-grounding conductive terminal 1113 at the electrical connector front end E1 to providing an electrical shielding environment for the signal transmission of the major non-grounding conductive terminal 1113, thereby reducing interference when transmitting high-speed signals, optimizing the transmission quality of the electrical connector 1 to meet the specific requirements and development of electronic devices.

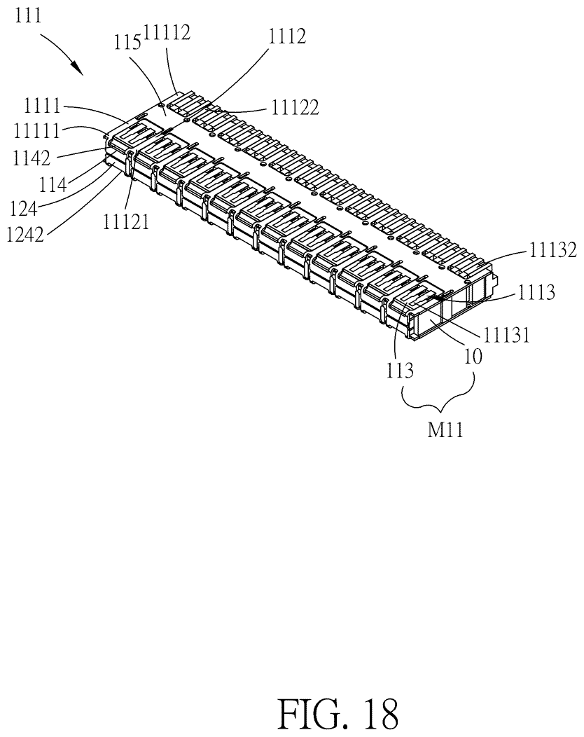

In the embodiments shown in FIGS. 5, 13, and 15, the major front conductive connecting body 114 comprises a major front wall shielding structure 1141, and the major front wall shielding structure 1141 provides a shielding wall for the major non-grounding conductive terminal 1113 at the electrical connector front end E1, providing an electrical shielding environment for signal transmission of the major non-grounding conductive terminal 1113. However, this is not limiting. In the embodiments illustrated in FIGS. 17 to 18, the major front conductive connecting body 114 comprises a major front connector hollow structure 1142, and the major front connector hollow structure 1142 provides impedance matching for the major non-grounding conductive terminal 1113 at the electrical connector front end E1.

Additionally, the major first grounding conductive terminal 1111 has a major first grounding terminal rear joining structure 11112. The major second grounding conductive terminal 1112 has a major second grounding terminal rear joining structure 11122. The major non-grounding conductive terminal 1113 has a major non-grounding terminal rear joining structure 11132. The major first grounding terminal rear joining structure 11112, the major second grounding terminal rear joining structure 11122, and the major non-grounding terminal rear joining structure 11132 can respectively join the rear conductive components and provide the transmission of electrical signals at the electrical connector rear end E2.

Correspondingly, the major rear conductive connecting body 115 extends at the electrical connector rear end E2 and spans over the major non-grounding conductive terminal 1113, electrically connecting the major first grounding conductive terminal 1111 and the major second grounding conductive terminal 1112, allowing the major rear conductive connecting body 115 to electrically connect to the major non-grounding terminal shielding wall W1, providing shielding for the major non-grounding conductive terminal 1113 at the electrical connector rear end E2, thereby providing an electrical shielding environment for the signal transmission of the major non-grounding conductive terminal 1113.

In the embodiment shown in FIG. 5, the major non-grounding conductive terminal 1113 also comprises a major non-grounding terminal rear bend structure 11133. The major non-grounding terminal rear bend structure 11133 provides bending to allow the major non-grounding conductive terminal 1113 to avoid contact with the major rear conductive connecting body 115, preventing electrical short circuits between the major non-grounding conductive terminal 1113 to avoid contact with the major rear conductive connecting body 115. The major first conductive plastic wall structure 102 and the major second conductive plastic wall structure 103 extend along the lateral sides of the major non-grounding terminal rear bend structure 11133, providing a shielding wall for the major non-grounding terminal rear bend structure 11133, thus providing an electrical shielding environment for signal transmission of the major non-grounding conductive terminal 1113.

In the embodiments shown in FIGS. 11 to 12, 14, and 16, the minor insulation terminal base 123 is combined (or connected) with the conductive plastic base 10 to form a minor conductive terminal mounting module M12. The minor conductive terminal mounting module M12 is configured to accommodate the minor first grounding conductive terminal 1211, the minor second grounding conductive terminal 1212, and the minor non-grounding conductive terminal 1213.

It should be noted that, in the minor conductive terminal mounting module M12, the minor non-grounding conductive terminal 1213 is positioned between the minor first grounding conductive terminal 1211 and the minor second grounding conductive terminal 1212. The minor first conductive plastic wall structure 105 and the minor second conductive plastic wall structure 106 are respectively abutted against the minor first grounding conductive terminal 1211 and the minor second minor conductive terminal 1212, enabling the conductive plastic base 10 to electrically connect the minor first grounding conductive terminal 1211 and the minor second grounding conductive terminal 1212 to allow the minor conductive plastic base body 104, the minor first conductive plastic wall structure 105, the minor second conductive plastic wall structure 106, the minor first grounding conductive terminal 1211, and the minor second grounding conductive terminal 1212 to form a minor non-grounding terminal shielding wall W2. The minor non-grounding terminal shielding wall W2 is capable of transmitting shielding signals, such as grounding signals, and has a U-shaped cross-section, allowing the minor non-grounding terminal shielding wall W2 to provide shielding wall on at least three sides of the minor non-grounding conductive terminal 1213 to create an electrically shielded environment for signal transmission of the minor non-grounding conductive terminal 1213, thereby reducing interference when transmitting high-speed signals. This optimization enhances the transmission quality of the electrical connector 1 for high-speed signals, meeting the specific requirements and advancements in electronic devices.

As shown in FIGS. 6, 12, and 14, the minor conductive plastic base body 104 electrically connects to the minor first conductive plastic wall structure 105 and the minor second conductive plastic wall structure 106, enabling to provide transmission of shielding signals, such as grounding signals. Additionally, the minor conductive plastic base body 104 extends around one side of the minor non-grounding conductive terminal 1213, thereby providing an electrically shielded environment for signal transmission of the minor non-grounding conductive terminal 1213.

Additionally, as shown in FIGS. 6 and 14, the minor first grounding conductive terminal 1211 and the minor second grounding conductive terminal 1212 are respectively inserted into the minor first conductive plastic wall structure 105 and the minor second conductive plastic wall structure 106, enabling the minor first grounding conductive terminal 1211 and the minor second grounding conductive terminal 1212 to electrically connect to the conductive plastic base 10. As shown in FIGS. 14, the minor conductive terminal mounting module M12 is located at the minor insulation terminal base 123. The minor first conductive plastic wall structure 105 and the minor second conductive plastic wall structure 106 respectively enter the minor insulation terminal base 123, thereby enabling to respectively abut to the minor first grounding conductive terminal 1211 and the minor second grounding conductive terminal 1212 in the way such as surface contact, respectively providing structural support to the minor first grounding conductive terminal 1211 and the minor second grounding conductive terminal 1212, reducing the degree of deformation experienced by the minor first grounding conductive terminal 1211 and the minor second grounding conductive terminal 1212.

The minor first grounding conductive terminal 1211 has a minor first grounding terminal front joining structure 12111. The minor second grounding conductive terminal 1212 has a minor second grounding terminal front joining structure 12121. The minor non-grounding conductive terminal 1213 has a minor non-grounding terminal front joining structure 12131. The minor first grounding terminal front joining structure 12111, the minor second grounding terminal front joining structure 12121, and the minor non-grounding terminal front joining structure 12131 can be respectively joined to the front end conductive component at the electrical connector front end E1 to provide the transmission of electrical signals.

Additionally, as shown in FIGS. 5 to 6, FIG. 14 and FIG. 16, the major front conductive connecting body 124 extends at the electrical connector front end E1 and spans over the minor non-grounding conductive terminal 1213, and electrically connects to the minor first grounding conductive terminal 1211 and the minor second grounding conductive terminal 1212, allowing the minor front conductive connecting body 124 to electrically connect to the minor non-grounding terminal shielding wall W2, providing shielding wall to the minor non-grounding conductive terminal 1213 at the electrical connector front end E1 to providing an electrical shielding environment for the signal transmission of the minor non-grounding conductive terminal 1213, thereby reducing interference when transmitting high-speed signals, optimizing the transmission quality of the electrical connector 1 to meet the specific requirements and development of electronic devices.

In the embodiments shown in FIGS. 5 and 14, the minor front conductive connecting body 124 comprises a minor front wall shielding structure 1241, and the minor front wall shielding structure 1241 provides a shielding wall for the minor non-grounding conductive terminal 1213 at the electrical connector front end E1, providing an electrical shielding environment for signal transmission of the minor non-grounding conductive terminal 1213. However, this is not limiting. In the embodiments illustrated in FIGS. 17 to 18, the minor front conductive connecting body 124 comprises a minor front connector hollow structure 1242, and the minor front connector hollow structure 1242 provides impedance matching for the minor non-grounding conductive terminal 1213 at the electrical connector front end E1.

Additionally, the minor first grounding conductive terminal 1211 has a minor first grounding terminal rear joining structure 12112. The minor second grounding conductive terminal 1212 has a minor second grounding terminal rear joining structure 12122. The minor non-grounding conductive terminal 1213 has a minor non-grounding terminal rear joining structure 12132. The minor first grounding terminal rear joining structure 12112, the minor second grounding terminal rear joining structure 12122, and the minor non-grounding terminal rear joining structure 12132 can respectively join the rear conductive components and provide the transmission of electrical signals at the electrical connector rear end E2.

Correspondingly, the minor rear conductive connecting body 125 extends at the electrical connector rear end E2 and spans over the minor non-grounding conductive terminal 1213, electrically connecting the minor first grounding conductive terminal 1211 and the minor second grounding conductive terminal 1212, allowing the minor rear conductive connecting body 125 to electrically connect to the minor non-grounding terminal shielding wall W2, providing shielding for the minor non-grounding conductive terminal 1213 at the electrical connector rear end E2, thereby providing an electrical shielding environment for the signal transmission of the minor non-grounding conductive terminal 1213.

In the embodiment shown in FIG. 5, the minor non-grounding conductive terminal 1213 also comprises a minor non-grounding terminal rear bend structure 12133. The minor non-grounding terminal rear bend structure 12133 provides bending to allow the minor non-grounding conductive terminal 1213 to avoid contact with the minor rear conductive connecting body 125, preventing electrical short circuits between the minor non-grounding conductive terminal 1213 to avoid contact with the minor rear conductive connecting body 125. The minor first conductive plastic wall structure 105 and the minor second conductive plastic wall structure 106 extend along the lateral sides of the minor non-grounding terminal rear bend structure 12133, providing a shielding wall for the minor non-grounding terminal rear bend structure 12133, thus providing an electrical shielding environment for signal transmission of the minor non-grounding conductive terminal 1213.

It should be noted that in the embodiments of the present application, the aforementioned components may also be omitted. For example, an electrical connector may optionally include only: a conductive plastic base, a major conductive terminal assembly, and a major insulation terminal base. The conductive plastic base includes a major conductive plastic base body, a major first conductive plastic wall structure, and a major second conductive plastic wall structure. The major conductive plastic base body electrically connects the major first conductive plastic wall structure and the major second conductive plastic wall structure. The major conductive terminal assembly is located on the electrical connector major side and includes a major first grounding conductive terminal, a major second grounding conductive terminal, and a major non-grounding conductive terminal. The major insulation terminal base is combined with the conductive plastic base to form a major conductive terminal mounting module. The major conductive terminal mounting module is configured to accommodate the major first grounding conductive terminal, the major second grounding conductive terminal, and the major non-grounding conductive terminal. In the major conductive terminal mounting module, the major non-grounding conductive terminal is located between the major first grounding conductive terminal and the major second grounding conductive terminal; and the major first conductive plastic wall structure and the major second conductive plastic wall structure are respectively abutted against the major first grounding conductive terminal and the major second grounding conductive terminal, allowing the conductive plastic base to electrically connect the major first grounding conductive terminal and the major second grounding conductive terminal, allowing the major conductive plastic base body, the major first conductive plastic wall structure, the major second conductive plastic wall structure, the major first grounding conductive terminal, and the major second grounding conductive terminal to form a major non-grounding terminal shielding wall, wherein the major non-grounding terminal shielding wall has a U-shaped cross-section, allowing the major non-grounding terminal shielding wall to provide shielding on at least three sides of the major non-grounding conductive terminal.

In summary, the electrical connector provided in this application can provide shielding walls to transmit shielded signals for at least three sides of the non-grounding conductive terminal, thereby effectively reducing interference when transmitting high-speed signals, and optimizing the transmission quality of the electrical connector for high-speed signals to meet the specific requirements and advancements of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, wherein one side of the electrical connector is an electrical connector major side, comprises:
a conductive plastic base, including a major conductive plastic base body, a major first conductive plastic wall structure, and a major second conductive plastic wall structure, and the major conductive plastic base body is electrically connected to the major first conductive plastic wall structure and the major second conductive plastic wall structure;
a major conductive terminal assembly, located on the electrical connector major side, consisting of a major first grounding conductive terminal, a major second grounding conductive terminal, and a major non-grounding conductive terminal; and
a major insulation terminal base, integrated with the conductive plastic base to form a major conductive terminal mounting module, and the major conductive terminal mounting module provides for the installation of the major first grounding conductive terminal, the major second grounding conductive terminal, and the major non-grounding conductive terminal; in the major conductive terminal mounting module,
the major non-grounding conductive terminal is positioned between the major first grounding conductive terminal and the major second grounding conductive terminal; and
the major first conductive plastic wall structure and the major second conductive plastic wall structure are respectively abutted against the major first grounding conductive terminal and the major second grounding conductive terminal, enabling the conductive plastic base to electrically connect the major first grounding conductive terminal and the major second grounding conductive terminal, allowing the major conductive plastic base body, the major first conductive plastic wall structure, the major second conductive plastic wall structure, the major first grounding conductive terminal, and the major second grounding conductive terminal to form a major non-grounding terminal shielding wall, wherein the major non-grounding terminal shielding wall has a U-shaped cross-section, allowing the major non-grounding terminal shielding wall to provide shielding on at least three sides of the major non-grounding conductive terminal.

2. The electrical connector of claim 1, wherein the front end of the electrical connector is an electrical connector front end, and the electrical connector further comprises a major front conductive connecting body, wherein the major front conductive connecting body extends at the electrical connector front end and spans over the major non-grounding conductive terminal, electrically connecting the major first grounding conductive terminal and the major second grounding conductive terminal, enabling the major front conductive connecting body to electrically connect to the major non-grounding terminal shielding wall, thereby providing electrical shielding to the major non-grounding conductive terminal at the electrical connector front end, wherein the major first grounding conductive terminal has a major first grounding terminal front joining structure, the major second grounding conductive terminal has a major second grounding terminal front joining structure, and the major non-grounding conductive terminal has a major non-grounding terminal front joining structure, additionally, the major first grounding terminal front joining structure, the major second grounding terminal front joining structure, and the major non-grounding terminal front joining structure are located at the electrical connector front end.

3. The electrical connector of claim 2, wherein the major front conductive connecting body comprises a major front wall shielding structure, and the major front wall shielding structure is provided at the electrical connector front end to serve as a shielding wall for the major non-grounding conductive terminal.

4. The electrical connector of claim 2, wherein the major front conductive connecting body comprises a major front connector hollow structure, and the major front connector hollow structure is hollowed out at the electrical connector front end to provide impedance matching for the major non-grounding conductive terminal.

5. The electrical connector of claim 1, wherein the major conductive plastic base body extends around one side of the major non-grounding conductive terminal.

6. The electrical connector of claim 1, wherein the rear end of the electrical connector is an electrical connector rear end, and the electrical connector also comprises a major rear conductive connecting body, and the major rear conductive connecting body extends at the electrical connector rear end and spans over the major non-grounding conductive terminal, electrically connecting the major first grounding conductive terminal and the major second grounding conductive terminal, enabling the major rear conductive connecting body to electrically connect to the major non-grounding terminal shielding wall, thereby providing electrical shielding to the major non-grounding conductive terminal at the electrical connector rear end, wherein the major first grounding conductive terminal has a major first grounding terminal rear joining structure, the major second grounding conductive terminal has a major second grounding terminal rear joining structure, and the major non-grounding conductive terminal has a major non-grounding terminal rear joining structure, additionally, the major first grounding terminal rear joining structure, the major second grounding terminal rear joining structure, and the major non-grounding terminal rear joining structure are located at the electrical connector rear end.

7. The electrical connector of claim 6, wherein the major non-grounding conductive terminal also includes a major non-grounding terminal rear bend structure, and the major non-grounding terminal rear bend structure provides bending to divert the major non-grounding conductive terminal away from the major rear conductive connecting body, and the major first conductive plastic wall structure and the major second conductive plastic wall structure extend from the lateral side of the major non-grounding terminal rear bend structure to provide a shielding wall for the major non-grounding terminal rear bend structure.

8. The electrical connector of claim 1, wherein the major first grounding conductive terminal and the major second grounding conductive terminal are respectively inserted into the major first conductive plastic wall structure and the major second conductive plastic wall structure, allowing the major first grounding conductive terminal and the major second grounding conductive terminal to electrically connect to the conductive plastic base.

9. The electrical connector of claim 1, wherein the major conductive terminal mounting module is located at the major insulation terminal base, and the major first conductive plastic wall structure and the major second conductive plastic wall structure respectively enter the major insulation terminal base, enabling to individually abut against the major first grounding conductive terminal and the major second grounding conductive terminal.

10. The electrical connector of claim 1, wherein the major first conductive plastic wall structure and the major second conductive plastic wall structure individually abut against the major first grounding conductive terminal and the major second grounding conductive terminal in surface contact, providing structural support for the major first grounding conductive terminal and the major second grounding conductive terminal respectively.

11. The electrical connector of claim 1, wherein the other side of the electrical connector is an electrical connector minor side, wherein the conductive plastic base also comprises a minor conductive plastic base body, a minor first conductive plastic wall structure, and a minor second conductive plastic wall structure, and the minor conductive plastic base body electrically connects the minor first conductive plastic wall structure and the minor second conductive plastic wall structure, and the electrical connector further includes:
a minor conductive terminal assembly, located on the electrical connector minor side, comprising a minor first grounding conductive terminal, a minor second grounding conductive terminal, and a minor non-grounding conductive terminal; and
a minor insulation terminal base, attached to the conductive plastic base to form a minor conductive terminal mounting module, and the minor conductive terminal mounting module provides placement for the minor first grounding conductive terminal, the minor second grounding conductive terminal, and the minor non-grounding conductive terminal; within the minor conductive terminal mounting module,
the minor non-grounding conductive terminal is positioned between the minor first grounding conductive terminal and the minor second grounding conductive terminal; and
the minor first conductive plastic wall structure and the minor second conductive plastic wall structure are respectively abutted against the minor first grounding conductive terminal and the minor second grounding conductive terminal, enabling the conductive plastic base to electrically connect to the minor first grounding conductive terminal and the minor second grounding conductive terminal, allowing the minor conductive plastic base body, the minor first conductive plastic wall structure, the minor second conductive plastic wall structure, the minor first grounding conductive terminal and the minor second grounding conductive terminal to form a minor non-grounding terminal shielding wall, and the minor non-grounding terminal shielding wall has a U-shaped cross-section, allowing the minor non-grounding terminal shielding wall to provide shielding walls on at least three sides of the minor non-grounding conductive terminal.

12. The electrical connector of claim 11, wherein the front end of the electrical connector is an electrical connector front end, and the electrical connector includes a minor front conductive connecting body, and the minor front conductive connecting body extends at the electrical connector front end and spans over the minor non-grounding conductive terminal, electrically connecting the minor first grounding conductive terminal and the minor second grounding conductive terminal, enabling the minor front conductive connecting body to electrically connect to the minor non-grounding terminal shielding wall and to provide the electrical shielding to the minor non-grounding conductive terminal at the electrical connector front end, wherein the minor first grounding conductive terminal has a minor first grounding terminal front joining structure, the minor second grounding conductive terminal has a minor second grounding terminal front joining structure, and the minor non-grounding conductive terminal has a minor non-grounding terminal front joining structure, additionally, the minor first grounding terminal front joining structure, the minor second grounding terminal front joining structure, and the minor non-grounding terminal front joining structure are located at the electrical connector front end.

13. The electrical connector of claim 11, wherein the minor front conductive connecting body comprises a minor front wall shielding structure, and the minor front wall shielding structure is provided at the electrical connector front end to serve as a shielding wall for the minor non-grounding conductive terminal.

14. The electrical connector of claim 11, wherein the minor front conductive connecting body comprises a minor front connector hollow structure, and the minor front connector hollow structure is hollowed out at the electrical connector front end to provide impedance matching for the minor non-grounding conductive terminal.

15. The electrical connector of claim 11, wherein the minor conductive plastic base body extends around one side of the minor non-grounding conductive terminal.

16. The electrical connector of claim 10, wherein the rear end of the electrical connector is an electrical connector rear end, and the electrical connector also comprises a minor rear conductive connecting body, and the minor rear conductive connecting body extends at the electrical connector rear end and spans over the minor non-grounding conductive terminal, electrically connecting the minor first grounding conductive terminal and the minor second grounding conductive terminal, enabling the minor rear conductive connecting body to electrically connect to the minor non-grounding terminal shielding wall, thereby providing electrical shielding to the minor non-grounding conductive terminal at the electrical connector rear end, wherein the minor first grounding conductive terminal has a minor first grounding terminal rear joining structure, the minor second grounding conductive terminal has a minor second grounding terminal rear joining structure, and the minor non-grounding conductive terminal has a minor non-grounding terminal rear joining structure, additionally, the minor first grounding terminal rear joining structure, the minor second grounding terminal rear joining structure, and the minor non-grounding terminal rear joining structure are located at the electrical connector rear end.

17. The electrical connector of claim 15, wherein the minor non-grounding conductive terminal also includes a minor non-grounding terminal rear bend structure, and the minor non-grounding terminal rear bend structure provides bending to divert the minor non-grounding conductive terminal away from the minor rear conductive connecting body, and the minor first conductive plastic wall structure and the minor second conductive plastic wall structure extend from the lateral side of the minor non-grounding terminal rear bend structure to provide a shielding wall for the minor non-grounding terminal rear bend structure.

18. The electrical connector of claim 11, wherein the minor first grounding conductive terminal and the minor second grounding conductive terminal are respectively inserted into the minor first conductive plastic wall structure and the minor second conductive plastic wall structure, allowing the minor first grounding conductive terminal and the minor second grounding conductive terminal to electrically connect to the conductive plastic base.

19. The electrical connector of claim 11, wherein the minor conductive terminal mounting module is located at the minor insulation terminal base, and the minor first conductive plastic wall structure and the minor second conductive plastic wall structure respectively enter the minor insulation terminal base, enabling to individually abut against the minor first grounding conductive terminal and the minor second grounding conductive terminal.

20. The electrical connector of claim 11, wherein the minor first conductive plastic wall structure and the minor second conductive plastic wall structure individually abut against the minor first grounding conductive terminal and the minor second grounding conductive terminal in surface contact, providing structural support for the minor first grounding conductive terminal and the minor second grounding conductive terminal respectively.

21. The electrical connector of claim 11, wherein the major insulation terminal base and the minor insulation terminal base can be formed separately or integrally.

22. The electrical connector of claim 11, wherein the major conductive plastic base body and the minor conductive plastic base body can be formed separately or integrally.
